(19) United States
(12) Patent Application Publication
(10) Pub. No.: US 2001/0052585 A1
(43) Pub. Date: Dec. 20, 2001

(54) Device for applying fluid material on a substrate, and application valve

(75) Inventors: H. J. Righolt, Oosterhout (NL); V. de Leeuw, Hilvarenbeek (NL)

Correspondence Address: KEVIN G. ROONEY, WOOD, HERRON & EVANS, L.L.P., 441 VINE STREET, 2700 CAREW TOWER, CINCINNATI, OH, 45202, US

(73) Assignee: Nordson Corporation, Westlake, OH (US)

(21) Appl. No.: 09/855,964

(22) Filed: May 15, 2001

(30) Foreign Application Priority Data
May 16, 2000 (DE) 10023672.3

(51) Int. Cl. F16K 31/02

(52) U.S. Cl. 251/129.18

(57) ABSTRACT

The present invention pertains to a device for applying fluid material on a substrate, with a supply canal for supplying material from a source of material, a main body with an outlet canal which communicates with the supply canal and ends in an outlet opening for delivering the material. A valve assembly located in the main body interrupts the flow of material in the outlet canal, which has a valve seat and a valve body which can move relative to the valve seat, as well as a tensioning device which pre-tensions the valve body in a closed or open position. A drive unit moves the valve body between a closed position which interrupts the flow of material and an open position which releases the flow of material. The supply canal is connected to the outlet canal in a lower part of the main body which is preferably close to the outlet opening, and the tensioning device for pre-tensioning the valve body is located in the lower area of the main body.

### FIELD OF THE INVENTION

The present invention pertains to a device for applying fluid material on a substrate. The device has a supply canal for supplying material from a source of material, a main body with an outlet canal which communicates with the supply canal and ends in an outlet opening for delivering the material, and with a valve assembly located in the main body for optional interruption of the flow of material in the outlet canal. The valve assembly has a valve seat and a valve body which can move relative to the valve seat, as well as a tensioning device which pre-tensions the valve body in a closed or open position. A drive unit moves the valve body between a closed position which interrupts the flow of material and an open position which releases the flow of material. The invention also pertains to an application valve for such an apparatus.

### BACKGROUND OF THE INVENTION

In many industrial applications, devices of the type described hereinabove are used for intermittent delivery and application of liquids onto various objects (substrates), for example in order to apply adhesives, coloring materials or the like onto automobile parts, packages, furniture or paper, on whole areas, in beads or in dots. The so-called application head with the valve assembly and nozzle assembly is part of a complex application system which includes a container for the fluid material, a transport pump and a control unit for controlling and/or regulating the individual components. The substrate can be moved relative to the application head with the help of a transport system, or the application head may be attached to a robot arm or the like and can move relative to the substrate.

Intermittent application means that the flow or stream of the fluid material in the supply canal, and thus the emission of the material from the outlet opening of the nozzle assembly, is alternately released or interrupted by intermittent activation of the valve assembly. In this way an interrupted pattern of material is created on the substrate; that is, for example, dots separated by intervals or interrupted longitudinal beads, or spaced rectangular sections of material when the material is applied on areas.

Particularly in applications where objects are to be moved past the application head at high speed and to have fluid material applied, intermittent interruption of the flow of material is necessary. At high relative speeds between the substrate and the application head and/or to create application patterns with small intervals between individual coated areas or short lengths - in the direction of relative motion - of coated area, the valve assembly must be activated at high switching frequency, or in other words, the valve body which interrupts the flow of material in the supply canal must be moved back and forth at high speed and high frequency.

In the case of an applicator which belongs to the state of technology, a coil spring is used to pre-tension the valve body in the closed position. The fluid material, for example, adhesive, is supplied in an upper area of the main body and then flows through a canal which runs essentially axially in the main body, toward the outlet opening of the outlet canal, at the same time flowing around the coil spring which is located in the outlet canal. A disadvantage of the known apparatus consists in the fact that the flow path for the material through the main body is relatively long, which leads to relatively great pressure losses. An additional known problem is that the coil spring can become stuck due to adhesive and the fluid material in the main body which may become subject to increased viscosity. The result of this is that fluid materials of higher viscosity in particular are difficult to process.

### SUMMARY OF THE INVENTION

The present invention provides an apparatus with which a valve assembly can be switched rapidly and with high frequency so that the flow of material can be interrupted or released with high frequency. In addition, the apparatus provides means by which materials with high viscosities, especially liquid adhesives, can be applied intermittently in a reliable manner.

The invention solves the problem of the type described hereinabove by having the supply canal located in a lower part of the main body and connected to the outlet canal, and with the tensioning device for pre-tensioning the valve body located in the lower area of the main body.

The benefits of the invention consist in the fact that possible pressure variations in the fluid material, especially in the supply canal, have little influence on the application and on the activation of the application valve. The total flow path, and thus the pressure loss within the applicator, is significantly smaller than in known devices. Furthermore, impairment of the tensioning device by the fluid material, especially sticking of the tensioning device, which is preferably in the form of a coil spring, can be largely prevented. Moreover, with the apparatus in accordance with the invention highly viscous fluids can be applied reliably, and high switching frequency of the valve assembly can be realized.

In one implementation, in which the tensioning device is a coil spring, beneficial provision is made for the valve assembly to be designed as a needle valve with an elongated, needle-like valve body, with an essentially ring-shaped projection on the valve body, against which the coil spring rests. In the ring-shaped projection are flow canals through which the fluid material can flow, producing a simple design with low resistance to flow.

In accordance with an alternative implementation, it is proposed that the outlet canal should run in the axial direction with reference to a longitudinal axis of the main body, and that the supply canal should run essentially in the radial direction in reference to the longitudinal axis of the main body and should end in the outlet canal in the area of the coil spring. This allows a compact construction to be achieved overall, and there is sufficient space available for connecting hoses or the like for feeding in the fluid material.

An alternative implementation of the invention is distinguished by the fact that the outlet canal runs at least partially inside of a sleeve which is inserted into the main body. A sleeve of this sort is easily manufactured and can be designed in such a way that its fluid mechanics are optimal, while the main body can consist of a different material. This optimizes the apparatus and lowers the overall production costs.

An additional preferred sample implementation of the invention calls for the drive unit for moving the valve body to have an electromagnetic coil arrangement to produce a magnetic field which operates on the valve body to move it to the closed or open position. A coil arrangement of this sort can be activated rapidly at high frequencies, so that a high switching frequency can be achieved for the valve assembly. A coil arrangement of this sort is easily controlled. This avoids the need for a source of pressurized air, such as is needed for pneumatically operated valves. The application of force needed to move the valve body can be amplified by locating at least one magnetically active element, preferably in the form of a pole element or flux ring, adjacent to or close to the coil.

Especially preferred is an implementation in which there is an adjusting element which can move relative to the main body and can be arrested stopped in various positions, forming a stop for the movable valve body, so that the stroke of the movable valve body is adjustable. Preferably, the adjusting element has male threading and can be screwed into the main body or into a threaded sleeve which is set into the main body.

In accordance with a refinement of the implementation described above, it is proposed that the adjusting element be in the form of a pole piece and that it be permeated by the magnetic field induced by the coil assembly, and that a force be generated which acts in the axial direction on the valve body to move the valve body back and forth. In one operating state the valve body preferably rests directly against the magnetically active adjusting element. By means of the magnetic field generated by the coil, a relatively strong force can be applied to the valve body which is to be moved. It is expedient for the adjusting element to be pre-tensioned relative to the main body by means of a coil spring.

In accordance with an additional aspect or a preferred implementation of the invention, an advantage of manufacturing technique results from having the main body made of synthetic material. The other components of the applicator can be embedded for example in a cast main body. If the applicator is subject to high mechanical loads, the main body can be enclosed in a housing made of a hardened material, such as a sheet metal.

It is further preferred that there be a separate connecting adapter with a section of the supply canal, which can be attached to the main body, into which a hose connector can preferably be screwed. This makes easy connections and attachments possible.

The invention is described below on the basis of a sample implementation of an applicator in accordance with the invention, with reference to the accompanying drawings. The figures show the following:

### BRIEF DESCRIPTION OF THE DRAWINGS

FIG. 1 is a cross-sectional view of an apparatus in accordance with the invention;

FIG. 2 is a partially cut away perspective view of an apparatus in accordance with the invention; and

FIG. 3 shows a top view of the apparatus of FIG. 2.

### DETAILED DESCRIPTION OF THE INVENTION

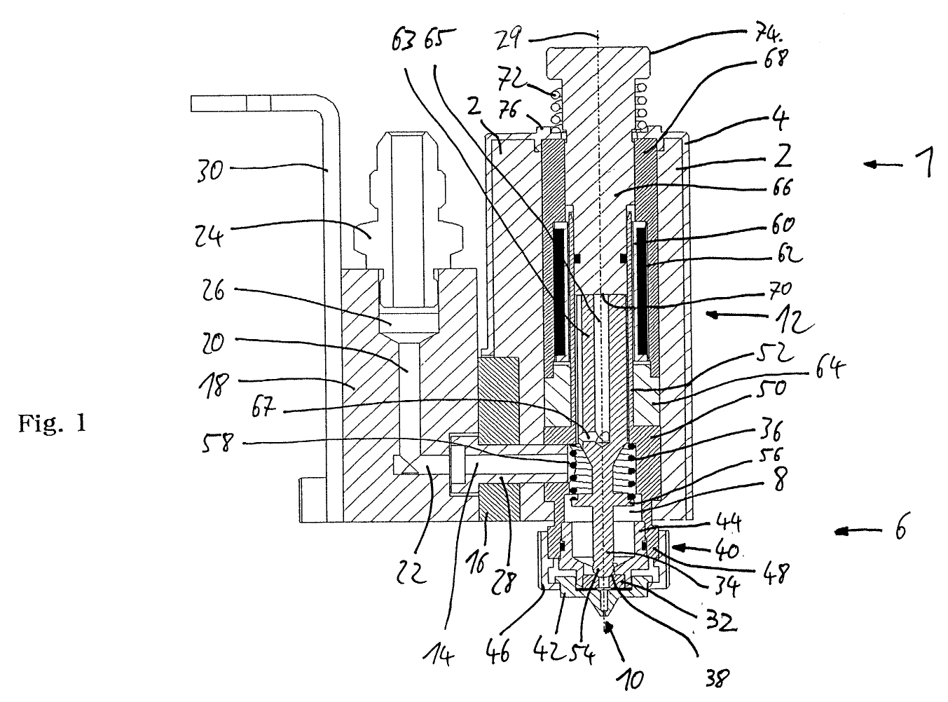

The device 1 illustrated on the basis of the sample implementation in accordance with FIGS. 1-3 is used to deliver and apply adhesive or other fluid materials on any desired substrate. The applicator head 1 is part of an application system which includes a source of material in the form of a container, a transport pump, lines or hoses through which the material can be transported to the applicator head 1, and control devices which are not shown for controlling and regulating individual components of the application system.

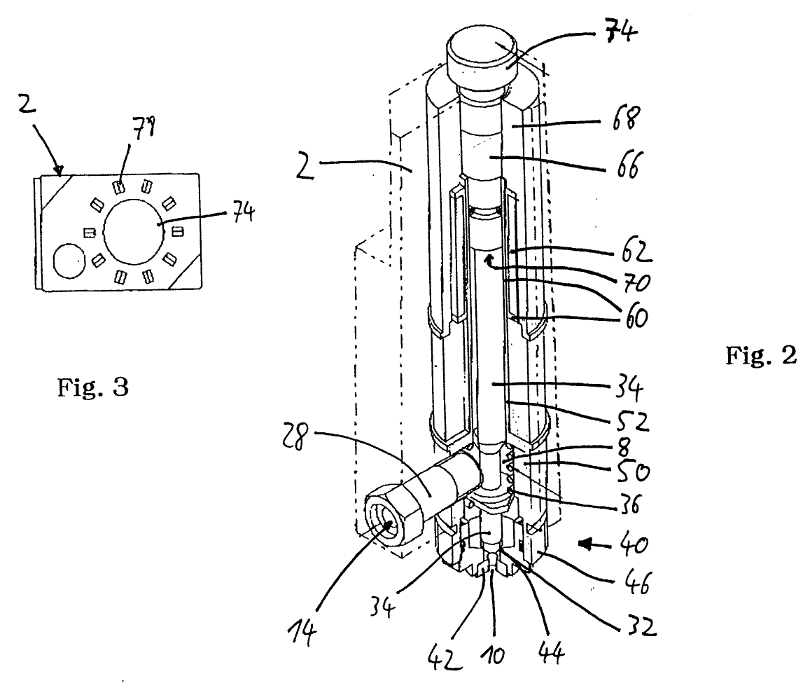

As can be seen from FIGS. 1 and 2, the applicator head 1 has a main body 2 of cast synthetic material, which can be a hardened casting material such as polyurethane. The main body 2 is surrounded by a protective housing 4, which can be manufactured for example by injection molding and can consist of polyamide. Located in the main body 2 are a valve assembly 6, an outlet canal 8 which ends in an outlet opening 10, and a drive unit 12 for the valve assembly 6. A supply canal 14 which is connected to the source of material communicates with the outlet canal 8.

A block-shaped connecting adapter 18 which is screwed onto the side of the main body 2 by means of a spacer plate 16 has a drilled hole 20 and a second drilled hole 22 at right angles to it. A hose connection adapter 24 is screwed into a threaded hole 26 which communicates with the canal 20, so that fluid material can flow through the hose, the connection adapter 24, the threaded hole 26, canals 20 and 22, and the supply canal 14, into the outlet canal 8, when the valve assembly 6 is in its open position.

The supply canal 14 is formed inside a sleeve 28 which is positioned radially relative to a longitudinal axis 29. The sleeve 28 is inserted through a hole drilled in the spacer plate 16 and the main body 2 and is screwed by its male threads into female threads in a sleeve 50. In the sleeve 28 there is a central flow canal which forms the supply canal 14. The connection adapter 18 is attached to the main body 2 by means of threaded connections. An assembly clamp 30 is provided for attaching the applicator head 1 to a frame, robot arm or the like, and is screwed onto the connection adapter 18.

The valve assembly 6 comprises a valve seat 32 and a valve body 34 which can move relative to the valve seat 32, and a tensioning device in the form of a coil spring 36 for pre-tensioning the valve body 34 in the closed position. The valve seat 32 has a contact surface 38, and is part of a nozzle assembly 40. The nozzle assembly 40 also includes a nozzle 42 which has the outlet opening 10, a sleeve 44 which partially limits the outlet canal 8, and a nut 46. The sleeve 50 has a mounting adapter 48. The nut 46 has female threads and is screwed onto the mounting adapter 48 on the sleeve 50 which is inserted into the main body 2 and which protrudes from the main body 2. The outlet canal 8 is formed in part by the hole drilled in the sleeve 50.

The valve body 34 in the form of an elongated needle is mounted on the main body 2, more precisely on an upper bearing section 52 of the sleeve 50, so that it can be moved axially back and forth translationally in the direction of the longitudinal axis 29, and can be moved from an open position, in which a ball-shaped lower part 54 of the valve body 34 is out of contact with the valve seat 32, so that a free flow section results, into a closed position in which the ball-shaped section 54 is in contact with the valve seat 32. The coil spring 36 is positioned inside the sleeve 50 and in the outlet canal 8. One end of the coil spring 36 is in contact with a projection formed on the sleeve 50, and the other end contacts a ring-shaped projection 56 formed on the valve body 34 and pre-tensions the valve body 34 in the direction of the closed position. In the projection 56 are flow canals (not shown), so that material can flow through in the direction of the outlet opening 10 of the outlet canal 8.

The outlet canal 8 formed in a lower area of the main body 2 runs essentially in the axial direction with respect to the longitudinal axis 29, while the supply canal 14 runs radially to the longitudinal axis 29.

In a lower section of the main body 2, that is, on the side of the outlet opening 10, the supply canal 14 is connected to the outlet canal 8. The flow path from the area where the supply canal 14 gives way to the outlet canal 8 (see reference symbol 58 in FIG. 1) until the outlet opening 10 is relatively short, so that only small losses of pressure occur. The tensioning device in the form of the coil spring 36 is also located in a lower section of the main body 2.

The drive unit 12 for moving the valve body 34 is an electromagnetic coil arrangement with a ring-shaped coil 60, which creates a magnetic field by means of which a force is exerted on the elongated, needle-like valve body 34 in the direction of the axis 29. Positioned concentric to the coil 60 is an upper, magnetizable, sleeve-shaped flux ring 68. Beneath the coil 60 is an additional adjoining magnetizable lower flux ring 64.

A pole piece 66 is positioned partially inside the ring-shaped coil 60 and is likewise magnetically operative. The arrangement of the pole piece 66, the flux ring 68 and the flux ring 64 causes a strong magnetic field to be formed, so that a strong axial force can be applied to the valve body 34 in order to move the closing body intermittently at high frequency from the open to the closed position and vice versa in conjunction with the coil spring 36. In the flux rings 64 and 68 there can be longitudinal slits (not shown) running in the direction of the longitudinal axis 29, which on the one hand make simple assembly possible and on the other hand ensure that a magnetic field which has been generated decays rapidly, so that high switching frequencies of the drive unit 12 and thus rapid movements of the valve body 34 at high frequency are possible.

Inside an upper bearing section 63 of the closing body 34 is a central drilled hole 65 and a transverse hole 67 connecting to it, so that fluid material can flow through at that point and possibly circulate when the closing body 34 is not in contact with the contact surface 70 of the pole piece 66.

At the same time the pole piece 66 is designed as an adjusting element 66 which can be moved relative to the main body 2 and arrested in various positions, forming a stop for the movable valve body 34, so that the stroke of the movable valve body is variable. For this purpose the pole piece or adjusting element 66 has male threads which engage female threads in a sleeve 68, so that when the pole piece 66 is rotated around the longitudinal axis 28 the pole piece 66 moves axially. This changes the position of the lower contact surface 70 of the pole piece 66 relative to the main body, so that the position of the pole piece, which functions as a stop for the valve body 34, is varied.

A pre-tensioning force is exerted on the pole piece 66 by means of a coil spring 72. The coil spring 72 is in contact with an extended grip section 74 which is knurled on its circumferential surface. The pole piece 66 can easily be turned manually by means of the grip section 74.

As can be seen from FIG. 3, on the surface of the housing 4 in the area of a projection 76 there are markings 78, which together with a marking (not shown) on the grip section 74 of the pole piece 66 constitute a measure of the axial position of the pole piece 66 and thus of the contact surface 70.

While the present invention has been illustrated by a description of a preferred embodiment and while this embodiment has been described in some detail, it is not the intention of the Applicants to restrict or in any way limit the scope of the appended claims to such detail. Additional advantages and modifications will readily appear to those skilled in the art. The various features of the invention may be used alone or in numerous combinations depending on the needs and preferences of the user. This has been a description of the present invention, along with the preferred methods of practicing the present invention as currently known.

However, the invention itself should only be defined by the appended claims, wherein we claim:

1. A device for applying fluid material on a substrate, said device comprising a supply canal for supplying material from a source of material, a main body with an outlet canal which communicates with the supply canal and ends in an outlet opening for discharging the material, said device further comprising a valve assembly located in the main body for optional interruption of the flow of material in the outlet canal, said valve assembly having a valve seat, a valve body which can move relative to the valve seat, a tensioning device which pre-tensions the valve body in a closed or open position and a drive unit for moving the valve body between a closed position which interrupts the flow of material and an open position which releases the flow of material, the supply canal being connected with the outlet canal in a lower section of the main body close to the outlet opening, the tensioning device for pre-tensioning the valve body being located in the lower area of the main body.

2. The device of claim 1, wherein the tensioning device is a coil spring which is braced on one side against the main body and on the other side against a section of the valve body.

3. The device of claim 2, wherein the valve assembly is designed as a needle valve with an elongated valve body, an essentially ring-shaped projection being formed on the valve body against which the coil spring is braced.

4. The device of claim 3, wherein the ring-shaped projection has flow canals, through which the fluid material can flow.

5. The device of claim 2, wherein the outlet canal runs in an axial direction in reference to a longitudinal axis of the main body, and the supply canal runs essentially in a radial direction in reference to the longitudinal axis of the main body and ends in the outlet canal in the area of the coil spring.

6. The device of claim 5, wherein the outlet canal runs at least partially inside of a sleeve inserted into the main body.

7. The device of claim 6, wherein the sleeve has a lower attaching projection spaced away from the main body, to which a nozzle assembly containing the outlet opening can be attached.

8. The device of claim 1, wherein the supply canal is bounded in the area of the main body by a sleeve with a central canal which can be inserted into it, the front section of which is inserted into the sleeve.

9. The device of claim 1, wherein the drive unit for moving the valve body has an electromagnetic coil arrangement to create a magnetic field, which operates upon the valve body to move it into the closed or open position.

10. The device of claim 9, wherein at least one magnetically operative element is located adjacent to a coil in order to amplify the force being applied to the valve body to move the valve body.

11. The device of claim 3, wherein the needle-like valve body tapers down conically in the area of the outlet canal in the direction of material flow.

12. The device of claim 1 further comprising an adjusting element which can move relative to the main body and can be arrested in various positions to form a stop for the movable valve body, so that the stroke of the movable valve body is adjustable.

13. The device of claim 12, wherein the adjusting element has male threading and can be screwed into a flux ring with threading which is on the main body or which can be inserted into the main body.

14. The device of claim 13, wherein the adjusting element is designed as a pole piece and is permeated by the magnetic field induced by the coil arrangement, so that a force is generated which operates on the valve body in the axial direction to move the valve body back and forth.

15. The device of claim 13, wherein the adjusting element is pre-tensioned relative to the main body by means of a coil spring.

16. The device of claim 1, wherein the main body is made of a synthetic material.

17. The device of claim 16, wherein the main body is enclosed by a housing made of an injection molded part.

18. The device of claim 17, wherein a separate connecting adaptor with a section of the supply canal can be attached to the main body, into which adapter a hose connector can be screwed.

19. The device of claim 17, wherein an attaching element for mounting on the main body is provided on the connection adapter.

20. An application valve with a valve assembly located on a main body for optionally interrupting the flow of a fluid material in an outlet canal, with a valve seat and a valve body which can move relative to the valve seat, and a tensioning device which pre-tensions the valve body in a closed or open position, and with a drive unit for moving the valve body between the closed and open positions, characterized by the fact that the tensioning device is located in an area in which a supply canal for supplying the fluid material ends in the outlet canal, and that the valve body has a top which is movable and can be arrested in various positions to limit the movability of the valve body.
